(19) United States
(12) Patent Application Publication
(10) Pub. No.: US 2008/0056259 A1
(43) Pub. Date: Mar. 6, 2008

(54) SWITCH APPARATUS AND SWITCHING METHOD FOR USE IN SAME

(75) Inventor: Akihiro MIYAMOTO, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 11/833,984

(22) Filed: Aug. 4, 2007

(30) Foreign Application Priority Data
Sep. 6, 2006 (JP) 2006-240913

(51) Int. Cl. H04L 12/56; H04J 3/00

(52) U.S. Cl. 370/391; 370/498

(57) ABSTRACT

A switch apparatus including a load-balance type switch which is configured with a front stage TDM switch, a middle stage switch, and a back stage TDM switch for realizing the switching of the packet signal, accommodating a TDM (Time Division Multiplex) signal and a packet signal, comprising: the front stage TDM switch being shared and used for switching the TDM signal and switching the packet signal, a connection path between an input interface and the front stage TDM switch being shared for a TDM switch connection and a packet switch connection, and the input interface of the TDM signal and the input interface of the packet signal being caused to be exchangeable with each other and configured to be compatible.

### INCORPORATION BY REFERENCE

This application is based upon and claims the benefit of priority from Japanese patent applications No. 2006-240913, filed on Sep. 9, 2006, the disclosure of which is incorporated herein its entirety by reference.

### BACKGROUND OF THE INVENTION

1. Field of the Invention

The present invention relates to a switch apparatus and a switching method for use in the same, and more specifically, to a TDM (Time Division Multiplex)-packet hybrid configuration and method for realizing switching of both a TDM signal and a packet signal using a single switch fabric in a switch apparatus accommodating both the signals.

2. Description of the Related Art

In future, in such a transition that a network migrates to an all packet network treating only packet system signal, it is necessary that a transport system apparatus accommodates also related TDM legacy transport system signal, and the seamless and hybrid processing of TDM signal-packet signal is required in the switching processing of that case.

When switching of TDM signal is executed in a related transmission system apparatus, a typical frame format for transmitting TDM signal to be switched is SONET (Synchronous Optical Network)/SDH (Synchronous Digital Hierarchy). SONET/SDH is a world standard frame format which hierarchically accommodates various speeds of interfaces in a grade structure such as 52 Mbps, 155 Mbps, 622 Mbps, 2.4 Gbps, and 10 Gbps to configure an economical digital network.

FIG. 13 illustrates one example of the SONET/SDH frame format, and this example is a frame format of STS-48 whose band is 2.4 Gbps. In this example, over head data is accommodated in a SOH (Section Over Head) part, and STS-48 payload data is accommodated in a payload part. STS-1 payload data (CH1 to CH48) whose band is 52 Mbps is 48-channel-byte-multiplexed in STS-48 payload.

As illustrated in FIG. 14, such a switching of the TDM signal is realized by previously setting an input port number selected at each time slot in each output port for inputted payload data. In an example of the SONET/SDH frame described above, one time slot corresponds to one byte, and data which is transmitted to the same destination and is byte-multiplexed for each channel is switched to an output port of a destination by selecting it according to the input port number set for each time slot.

On the other hand, a general switch configuration which processes packet signal includes an input buffer type switch, an output buffer type switch, and a common buffer type switch. FIG. 15 is a block diagram illustrating a configuration of the input buffer type switch. The input buffer type switch provides a buffer a1 for buffering fixed length cells in each input port for waiting operation in case that destination ports of fixed length cells inputted from plural input ports are same.

This configuration of the switch has such a fault that because the second and subsequent fixed length cells of a buffer a1 can not be outputted until a fixed length cell at a head of the buffer a1 of an input port is outputted, if the fixed length cell stored in the head of the buffer a1 is caused to wait due to the competition of a destination output port with a fixed length cell of another input port, even if a destination port of the second fixed length cell does not compete, it becomes to be in such a state that it can not be outputted (HOL blocking: Head Of Line blocking), so that the decrease of throughput occurs.

To countermeasure this fault, FIG. 16 is an embodiment of such an input buffer type switch that a buffer b1 of each input port is provided for each destination output port (VOQ: Virtual Output Queue). However, because it is necessary to execute the scheduling for all the paths (the number of all input ports×the number of all output ports) which determines to cause a fixed length cell to be transferred from which input port to which output port, the amount of calculation is increased (increase of H/W (hard ware) size), so that the embodiment of FIG. 16 has such a fault that it is difficult to realize in consideration of accommodating many ports.

FIG. 17 is a block diagram illustrating a configuration of the output buffer type switch. In the output buffer type switch, fixed length cells inputted from all input ports are multi-processes and outputted to each output port as signal whose speed is N times (N: the number of accommodated ports) as high as that of the input port. In the output port, buffers c2 for buffering fixed length cells are provided for waiting in case that the fixed length cells from plural input ports arrive as temporarily concentrated. In this configuration of the switch, a processing speed which is N times (N: the number of input ports) as high as the interface speed is necessary as an internal processing speed of the switch, so that the embodiment of FIG. 17 has such a fault that it is difficult to realize in consideration of increasing the port speed and accommodating many ports.

FIG. 18 is a block diagram illustrating a configuration of the common buffer type switch. In the common buffer type switch, a buffer d2 commonly used for all ports is provided between an input port and an output port. The fixed length cells inputted from all input ports are multi-processed and caused to be signals whose speed is N times (N: the number of input ports) as high as the input port speed, and are written to buffer d2, and the fixed length cells outputted to each output port at the same speed as the write speed are read. In this configuration of the switch, a processing speed which is N times (N: the number of input ports) as high as the interface speed is necessary as an internal processing speed of the switch, so that the embodiment of FIG. 18 has such a fault that it is difficult to realize in consideration of increasing the port speed and accommodating many ports.

A load-balance type cell switch has a switch configuration which deletes a scheduler processing for all input and output ports of the input buffer type switch, and does not need the increase of the internal processing speed because of the increase of the number of accommodated ports like the output buffer type switch and the common buffer type switch. A configuration of the typical load-balance type cell switch is disclosed in Non Patent Document 1 (Isaac Keslassy, “The Load-Balanced Router”, Ph. D. Dissertation, Stanford University, June 2004). Meanwhile, it is assumed that a switching processing is performed by the fixed length cell in the load-balance type cell switch. While it is also estimated that a variable length packet is inputted to the input and output to a load-balance type switch system, in this case, it is assumed that the variable length packet is divided to fixed length cells when inputting to the load-balance type switch, and is combined from the fixed length cells into the variable length packet and is restored to the original when outputting from the load-balance type switch.

FIG. 19 illustrates a configuration example of the load-balance type switch. The load-balance type cell switch includes input interfaces e1-1 to e1-N, a front stage TDM switch e2, middle buffers e3-1 to e3-N, a back stage TDM switch e4, and output interfaces e5-1 to e5-5. Here, while the number of any one of the input interfaces, the middle buffers, and output interfaces is expressed as N, it is permitted that the numbers of the input interfaces, the middle buffers, and the output interfaces are different from each other.

The input interfaces e1-1 to e1-N are interface blocks accommodating cell data of the speed R. The front stage TDM switch e2 is a switch for distributing (load-balancing) cells received by the input interfaces e1-1 to e1-N to all the middle buffers e3-1 to e3-N, and the back stage TDM switch e4 is a switch for distributing cells from the middle buffers e3-1 to e3-N to the output interfaces e5-1 to e5-N, destinations of each cell.

A feature of the load-balance-type switch is an equal distribution to those middle buffers e3-1 to e3-N. In order to equally distribute cells to N locations of the middle buffers e3-1 to e3-N, if a cell receiving rate of the input interfaces e1-1 to e1-N is R, it is enough to be able to transmit cells at a speed of R/N from each input stage to the front stage TDM switch e2 respectively, and also it is enough for the front stage TDM switch e2 to be in such a periodical port selection setting that cells are equally distributed to each of the middle buffers e3-1 to e3-N.

As described above, because it is a switching by the periodical port selection setting in the load-balance type switch, this operation is an operation of a TDM switch. Similarly, regarding a cell transfer from the middle buffers e3-1 to e3-N to some output interface, it is estimated that because the input interfaces e1-1 to e1-N equally distribute cells to the middle buffers e3-1 to e3-N, the cells are transferred at the same rate from each of the middle buffers e3-1 to e3-N to some of output interfaces e5-1 to e5-N.

Thus, it is enough to be able to transmit cells at the speed of R/N also from each of the middle buffers e3-1 to e3-N to the back stage TDM switch e4 respectively, and the back stage TDM switch e4 is also caused to be in a TDM switch operation setting, the destination is decided by the middle buffers e3-1 to e3-N side, and cells are outputted at a timing of a time slot corresponding to a destination port.

As described above, the features of the load-balance type switch are that it is enough to connect at such a transfer rate that the cell receiving rate R is divided by the number of the middle buffers e3-1 to e3-N, N, between the input interface—the front stage TDM switch—the middle stage buffer, and between the middle stage buffer—the back stage TDM switch—the output interface, and the front stage TDM switch e2 and the back stage TDM switch e4 operate in a TDM switch mode with a periodical port selection setting.

As described above, in the load-balance type cell switch, the increase of device processing speed because of the increase of the number of ports to be accommodated and the scheduler processing which is necessary for the input buffer type switch are caused to be unnecessary by distributing load per middle buffer by once distributing cells to the middle buffers e3-1 to e3-N located at the middle of the input and the output interfaces, and transferring the cells from each of the middle buffers e3-1 to e3-N to the output interfaces e5-1 to e5-N, the original destinations of the cells.

In the TDM-packet hybrid switch method according to the present invention, it is necessary to realize both of the switching of TDM signal and the switching of packet signal described above.

An example of the related TDM-packet hybrid switch is disclosed in Patent Document 1 (Japanese Patent Laid-Open No. 7-111517). As illustrated in FIG. 20, the TDM-packet hybrid switch described in this Patent Document 1 is configured to be able to execute the switching processing for input of TDM signal and packet signal as a whole of an apparatus f by including a TDM switch f5 and a packet switch f6 which independently execute the switching processing for inputted TDM signal and packet signal.

However, because this configuration independently includes the TDM switch f5 and the packet switch f6, and the connection path between the input and output interface unit—the switch unit is not shared by TDM switch connection and packet switch connection, if the total switch capacity required for one apparatus is L, it is not possible to flexibly distribute the capacity L to a part for processing TDM signal and a part for processing packet signal. That is, it is not possible to flexibly distribute the number of the mounted input and output interface units for TDM signal and the number of the mounted input and output interface units for packet signal.

An example of the related TDM-packet hybrid switch which switches both a TDM signal and a packet signal using a single switch fabric is disclosed in Patent Document 2 (Japanese Patent Laid-Open No. 2004-208190). As illustrated in FIG. 21, in the TDM-packet hybrid switch disclosed in this Patent Document 2, the single switch fabric is a TDM switch g9.

Thus, while the processing for TDM signal may be completely the same as a normal switching processing, in the processing for packet signal, it is necessary to output packet signal to the TDM switch g9 after mapping it on a format which is suitable to the TDM switching. This technology for mapping on a format which is suitable to the TDM switching is the virtual concatenation (VC) technology which maps packet signal on SONET/SDH frame format.

FIGS. 22A and 22B are conceptual diagrams of the virtual concatenation, and illustrates, for example, the case that 100 Mbps path (STS-1-2V) is provided for 2.4 Gbps frame format, STS-48, by binding two paths of STS-1, 52 Mbps signal, as illustrated in FIG. 22A, and the case that 500 Mbps path (STS-1-10V) is provided, by binding ten paths of STS-1, 52 Mbps signal, as illustrated in FIG. 22B.

As described above, the virtual concatenation constructs interfaces on SONET/SDH frame format whose band speeds are hierarchical bands such as 52 Mbps, 155 Mbps, 622 Mbps, 2.4 Gbps, and 10 Gbps and also other band speeds by smaller step in the middle (100 Mbps, 500 Mbps in this example). As illustrated in FIG. 21, this switching of packet signal is executed by cellizing packet signal, mapping on SONET/SDH frame by the virtual concatenation processing, and switching in the TDM switching unit. In the output interface side, cells are extracted and the packet is assembled.

By this configuration, the switch unit becomes a single fabric of the TDM switch, and, by including the TDM switch of the switch capacity L, can flexibly distribute the total switch capacity L to a part for processing TDM signal and a part for processing packet signal. That is, it is possible to flexibly distribute the number of the mounted input and output interface units for TDM signal and the number of the mounted input and output interface units for packet signal.

However, the above configuration has such a fault that because the switch unit is a TDM switch, a path from an input port to an output port is constructed for inputted packet signal at a fixed band speed mapped by the virtual concatenation.

When packet signal is switched, not a switching path of a fixed band such as a TDM switch, but a switching path of a free band should be originally constructed corresponding to a destination of inputted packet signal between an input interface and an output interface. That is, in a specific output interface port, packet signal traffic concentrates in some time zone, and few packet signal traffic comes in another time zone, so that such traffic switching processing should be realized in the packet signal switching.

A configuration of the above related example has such a fault that a path from one input interface port to one output interface port is limited with a fixed band speed in the packet signal switching.

In the above related switching processing, there is such a problem that when an apparatus includes a TDM switch and a packet switch separately, and a connection path between input and output interface unit-switch unit is not shared by a TDM switch connection and a packet switch connection, the total switch capacity required for one apparatus can not be flexibly distributed to a part for processing TDM signal and a part for processing packet signal.

And, in the related switching processing, there is such a problem that when packet signal mapped on SONET/SDH frame by the virtual concatenation processing is switched with a single fabric TDM switch, a path from one input interface port to one output interface port is limited with a fixed band speed in the packet signal switching.

### SUMMARY

An exemplary object of the present invention is to provide a switch apparatus and a switching method for use in the same, which resolves the above problem, secures the flexibility of mounting capacity distribution for TDM signal and packet signal, and can realize the packet signal switching which does not limit a path between the input and output interface ports to a fixed band speed.

An exemplary aspect of the present invention is a switch apparatus including a load-balance type switch which is configured with a front stage TDM switch, a middle stage switch, and a back stage TDM switch for realizing the switching of the packet signal, accommodating a TDM (Time Division Multiplex) signal and a packet signal, including:

the front stage TDM switch being shared and used for switching the TDM signal and switching the packet signal,

a connection path between an input interface and the front stage TDM switch being shared for a TDM switch connection and a packet switch connection,

and the input interface of the TDM signal and the input interface of the packet signal being caused to be exchangeable with each other and configured to be compatible.

Another exemplary aspect of the present invention is a switching method used in a switch apparatus including a load-balance type switch which is configured with a front stage TDM switch, a middle stage switch, and a back stage TDM switch for realizing to switch the packet signal, accommodating a TDM (Time Division Multiplex) signal and a packet signal, including:

sharing and using the front stage TDM switch for switching the TDM signal and switching the packet signal;

sharing a connection path between an input interface and the front stage TDM switch for a TDM switch connection and a packet switch connection; and

causing the input interface of the TDM signal and the input interface of the packet signal to be exchangeable with each other and configured to be compatible.

That is, a switch apparatus of the present invention is a switch apparatus of TDM (Time Division Multiplex)—packet hybrid switch method, and is characterized in that a front stage TDM switch unit is used as shared with the switching of TDM signal in a configuration of the load-balance type switch configured with a front stage TDM switch, a middle stage switch, and a back stage TDM switch for realizing the switching of packet signal.

As described above, in a switch apparatus of the present invention, it becomes to be possible to secure the flexibility of mounting capacity distribution for TDM signal and packet signal and realize the packet signal switching which does not limit a path between the input and output interface ports to a fixed band speed by configuring a TDM-packet hybrid switch with a single switch fabric.

The present invention can obtain such an effect that it is possible to secure the flexibility of mounting capacity distribution for TDM signal and packet signal and realize the packet signal switching which does not limit a path between the input and output interface ports to a fixed band speed with the above configuration and operation.

### BRIEF DESCRIPTION OF THE DRAWINGS

FIG. 1 is a block diagram illustrating a configuration example of a switch apparatus according to an exemplary embodiment of the present invention;

FIG. 2 is a block diagram illustrating a configuration example of a TDM signal input interface of FIG. 1;

FIG. 3 is a block diagram illustrating a configuration example of a packet signal input interface of FIG. 1;

FIG. 4 is a block diagram illustrating a configuration example of a front stage TDM switch of FIG. 1;

FIG. 5 is a block diagram illustrating a configuration example of a middle stage switch of FIG. 1;

FIG. 6 is a block diagram illustrating a configuration example of a back stage TDM switch of FIG. 1;

FIG. 7 is a block diagram illustrating a configuration example of a TDM signal output interface of FIG. 1;

FIG. 8 is a block diagram illustrating a configuration example of a packet signal output interface of FIG. 1;

FIG. 9 is a diagram illustrating a format example of cellized data according to an exemplary embodiment of the present invention;

FIG. 10 is a block diagram illustrating a configuration example of a switch apparatus according to another exemplary embodiment of the present invention;

FIG. 11 is a block diagram illustrating a configuration example of a middle stage switch of FIG. 10;

FIG. 12 is a block diagram illustrating a configuration example of a front stage TDM switch of FIG. 10;

FIG. 13 is a diagram illustrating SONET/SDH frame format example;

FIG. 14 is an image illustrating port selection setting of a TDM switch;

FIG. 15 is a block diagram illustrating an input buffer type switch configuration;

FIG. 16 is a block diagram illustrating such an input buffer type switch configuration that buffer of each input port is provided for each destination output port (VOQ);

FIG. 17 is a block diagram illustrating an output buffer type switch configuration;

FIG. 18 is a block diagram illustrating a common buffer type switch configuration;

FIG. 19 is a block diagram illustrating a load-balance type switch configuration;

FIG. 20 is a block diagram illustrating a configuration of a related TDM-packet hybrid apparatus;

FIG. 21 is a block diagram illustrating a configuration of another related TDM-packet hybrid apparatus; and

FIGS. 22A and 22B are images illustrating mapping technology (virtual concatenation) of packet data on SONET/SDH frame.

### EXEMPLARY EMBODIMENT

Next, exemplary embodiments of the present invention will be described referring to the drawings.

### First Exemplary Embodiment

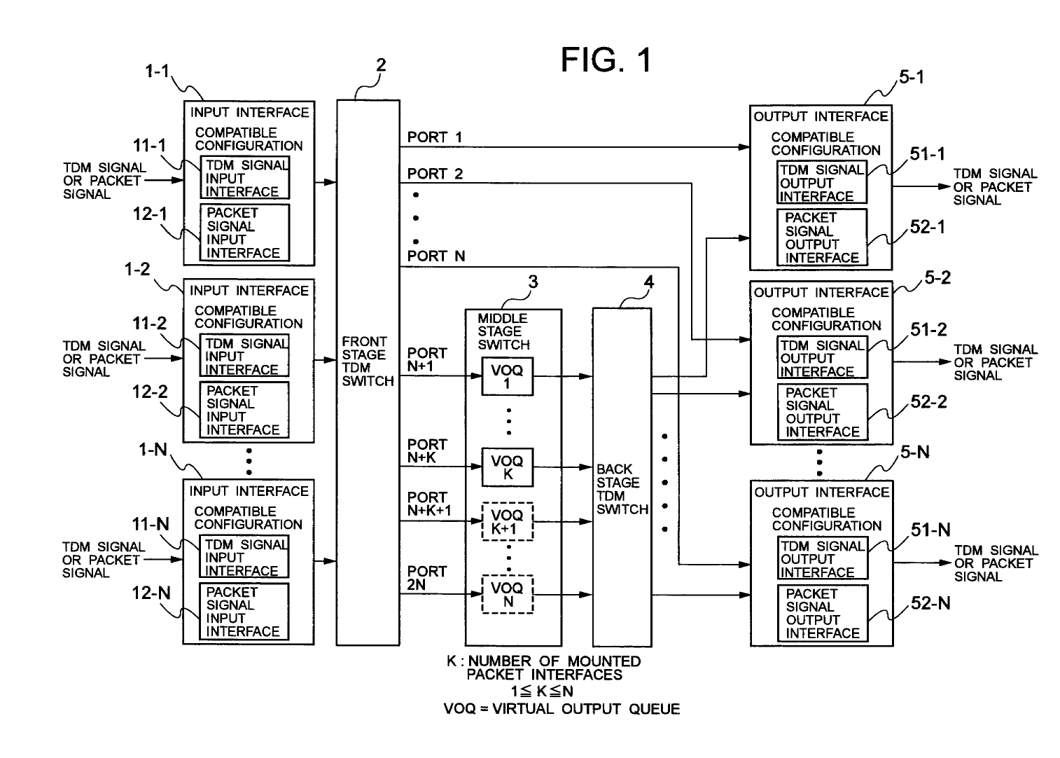

FIG. 1 is a block diagram illustrating a configuration example of a switch apparatus according to an exemplary embodiment of the present invention. In FIG. 1, the switch apparatus according to the exemplary embodiment of the present invention is configured to include input interface units 1-1 to 1-N, a front stage TDM (Time Division Multiplex) switch 2, a middle stage switch 3, a back stage TDM switch 4, and output interface units 5-1 to 5-N.

The input interface units 1-1 to 1-N input-interface TDM signal or packet signal, and the internal configuration is such a compatible configuration that TDM signal input interface units 11-1 to 11-N input-interfacing with TDM signal represented by SONET (Synchronous Optical Network)/SDH (Synchronous Digital Hierarchy) frame data, and packet signal input interface units 12-1 to 12-N are exchangeable with each other.

The front stage TDM switch 2 executes TDM switching of TDM signal, and TDM switching to cause packet signal to load-balance to the middle stage switch 3. This front stage TDM switch 2 is a switch of N×2N to connect to the output interface units 5-1 to 5-N when TDM signal input interface units 11-1 to 11-N are fully mounted with N ports, and to connect to the middle stage switch 3 when packet signal input interface unit 12-1 to 12-N are fully mounted with N ports.

The middle stage switch 3 buffers load-balanced packet signal for each destination. The back stage switch 4 switches the packet signal buffered by the middle stage switch 3 for each destination.

The output interface units 5-1 to 5-N output-interface switched TDM signal or packet signal, and the internal configuration is such a compatible configuration that TDM signal output interfaces 51-1 to 51-N and packet signal output interfaces 52-1 to 52-N are exchangeable with each other.

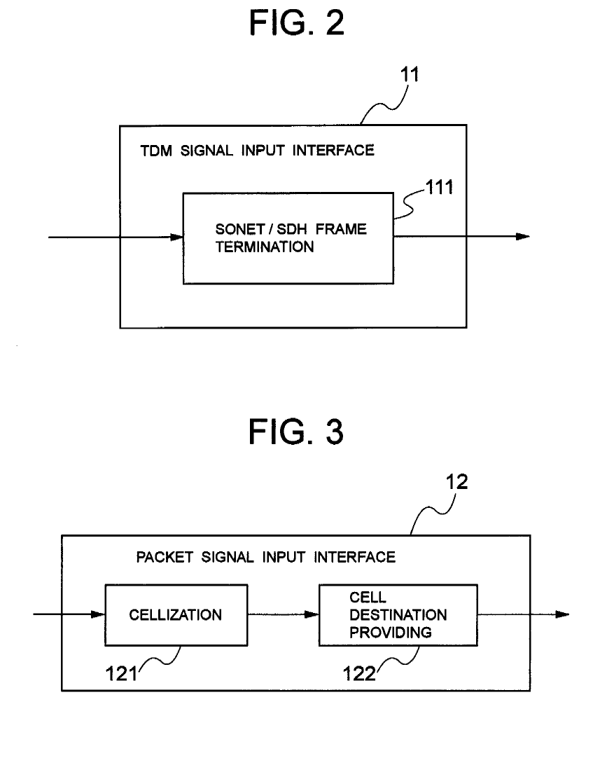

FIG. 2 is a block diagram illustrating a configuration example of the TDM signal input interface units 11-1 to 11-N of FIG. 1. In FIG. 2, the TDM signal input interface units 11-1 to 11-N (described as TDM signal input interface 11) are configured with SONET/SDH frame termination unit 111.

FIG. 3 is a block diagram illustrating a configuration example of the packet signal input interface units 12-1 to 12-N of FIG. 1. In FIG. 3, the packet signal input interface units 12-1 to 12-N (described as packet signal input interface 12) includes a cellizing unit 121 which divides inputted packet signal to fixed-length cells, and a cell destination providing unit 122 which provides destination of each divided cell for a cell header by detecting the destination from a header of a packet in the case of cellizing.

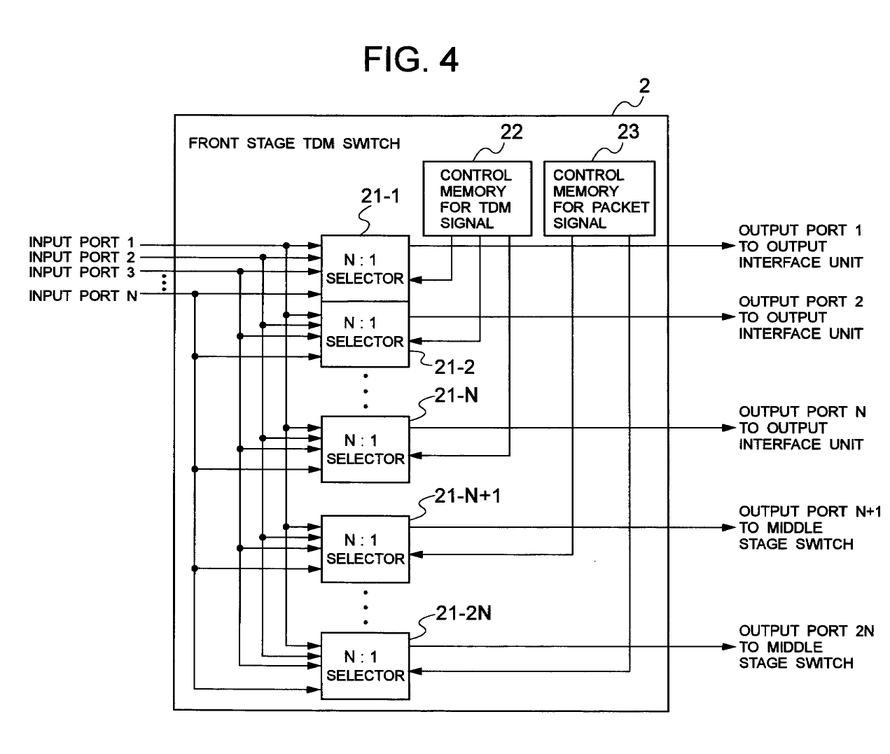

FIG. 4 is a block diagram illustrating a configuration example of the front stage TDM switch 2 of FIG. 1. In FIG. 4, the front stage TDM switch 2 includes N:1 selectors 21-1 to 21-2N which selects one set of input signal from N sets of input signal for each output port as a switching operation for TDM signal or packet signal inputted from input ports 1 to N, a TDM signal control memory 22 which designates a port to be selected from the N:1 selectors 21-1 to 21-2N at each time slot as a TDM switching operation for TDM signal input ports, and a packet signal control memory 23 which designates a port to be selected from the N:1 selectors 21-1 to 21-2N at each time slot as a TDM switching operation for load-balancing to the middle stage switch 3 for packet signal input ports.

Here, in FIG. 4, while the input port side has N sets of inputs to cause TDM signal and packet signal be configured to be compatible, when TDM signal is selected, it is selected by the N:1 selectors 21-1 to 21-2N connected to the output interfaces 5-1 to 5-N, and when packet signal is selected, it is selected by the N:1 selectors 21-1 to 21-2N connected to the middle stage switch 3. Thus, the N:1 selectors 21-1 to 21-2N need 2N sets as total of N sets of TDM signal output ports and N sets of packet signal output ports, and the front stage TDM switch 2 become to be a N×2N switch.

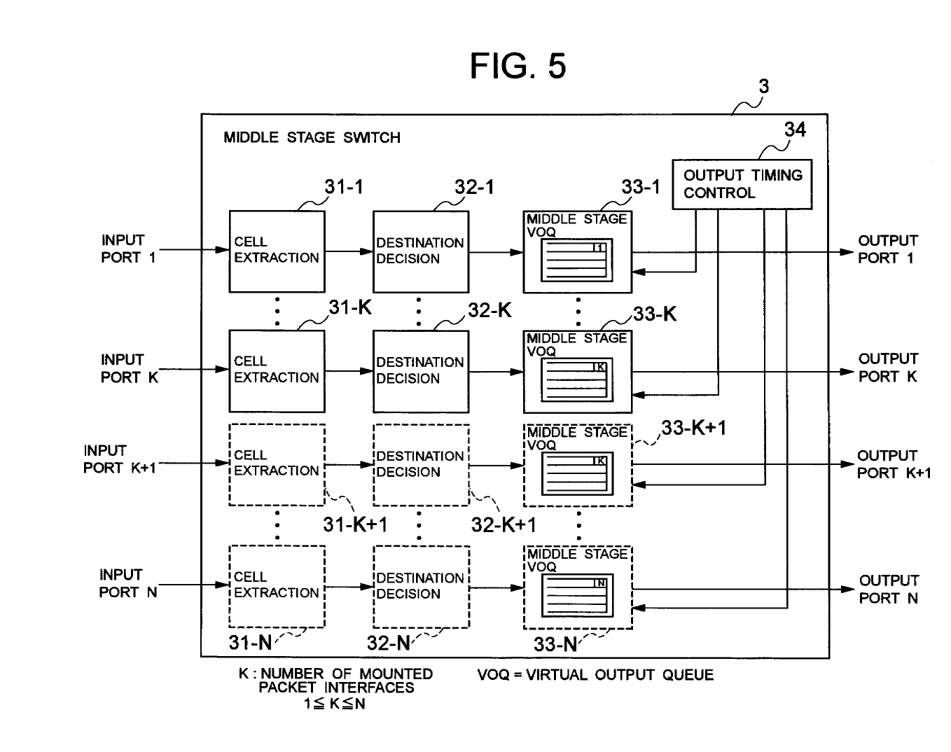

FIG. 5 is a block diagram illustrating a configuration example of the middle stage TDM switch 3 of FIG. 1. In FIG. 5, the middle stage switch 3 includes cell extracting units 31-1 to 31-N which identify a cell header part of input signal from the front stage TDM switch 2, destination decision units 32-1 to 32-N which detect destination information of each cell from the identified cell header and decides to store the information in which queue of a subsequent middle stage buffer (middle stage VOQ (Virtual Output Queue)), middle stage VOQs 33-1 to 33-N which buffer packet signal which is cellized and load-balanced by the front stage TDM switch 2 for each destination, and an output timing control unit 34 which controls timing for outputting cells from the middle stage VOQs 33-1 to 33-N to the back stage TDM switch 4.

Here, it is assumed that the number of mounted ports of packet signal input output interface is K (1≦K≦N), and only K sets of the cell extracting units, the destination decision units, and the middle stage VOQs are mounted to avoid the unnecessary increase of circuit size. In FIG. 5, this un-mounted part is illustrated with dotted line.

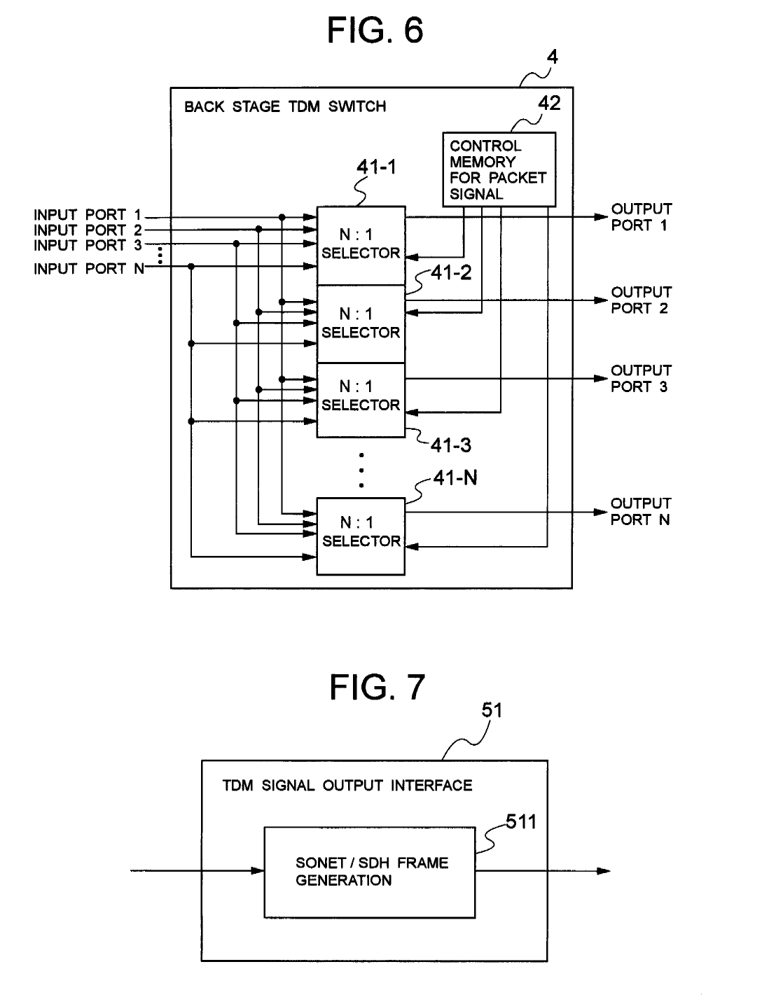

FIG. 6 is a block diagram illustrating a configuration example of the back stage TDM switch 4 of FIG. 1. In FIG. 6, the back stage TDM switch 4 includes N:1 selectors 41-1 to 41-N which select one set from N sets of input signal for each output port as a switching operation for packet signal which is cellized and inputted from the input ports 1 to N, and a packet signal control memory 42 which designates a port to be selected of the N:1 selectors 41-1 to 41-N at each slot time as a TDM switching operation.

FIG. 7 is a block diagram illustrating a configuration example of the TDM signal output interfaces 51-1 to 51-N of FIG. 1. In FIG. 7, the TDM signal output interfaces 51-1 to 51-N (described as TDM signal output interface 51) is configured with SONET/SDH frame generation unit 511.

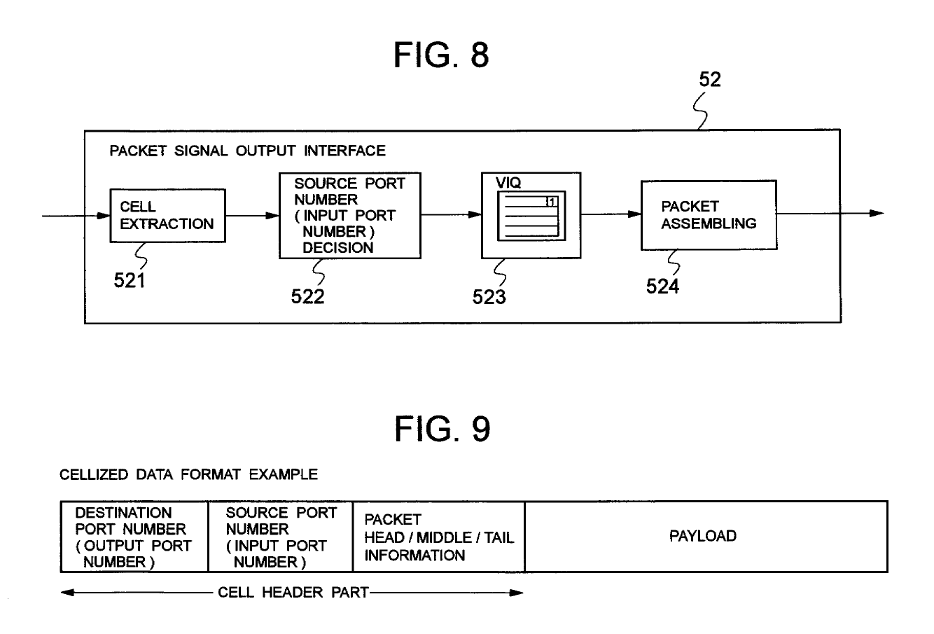

FIG. 8 is a block diagram illustrating a configuration example of the packet signal output interfaces 52-1 to 52-N of FIG. 1. In FIG. 8, the packet signal output interfaces 52-1 to 52-N (described as packet signal output interface 52) includes a cell extracting unit 521 which identifies a cell header part for input signal from the back stage TDM switch 4, a source port number (input port number) decision unit 522 which detects input port information from the identified cell header which indicates what input port each cell has come from, and decides to store the information in what queue of the subsequent VIQ (Virtual Input Queue), VIQ 523, and a packet assembling unit 524 which returns the divided cells to packet for each source port (input port).

FIG. 9 is a diagram illustrating a format example of cellized data according to an exemplary embodiment of the present invention. In FIG. 9, the cellized data includes cell header part including destination port number (output port number), a source port number (input port number), and packet header/middle/tail information, and pay load.

Operations of a switch apparatus according to the exemplary embodiment of the present invention will be described referring to such FIG. 1 to FIG. 9.

As illustrated in FIG. 1, the switch apparatus according to the exemplary embodiment of the present invention uses the front stage TDM switch 2 as shared with the switching of TDM signal in a configuration of a load-balance type switch configured with the front stage TDM switch 2 and the middle stage switch 3 and the back stage TDM switch 4 for realizing the switching of packet signal. That is, a function of a TDM switch is realized at same time within one switch fabric for realizing packet switch.

As described above, because a switch fabric of a TDM switch and a packet switch do not exist separately, the TDM signal input interfaces 11-1 to 11-N and the packet signal input interfaces 12-1 to 12-N can be exchangeable with each other and configured to be compatible. And, as described in FIG. 1, the TDM signal output interfaces 51-1 to 51-N and the packet signal output interfaces 52-1 to 52-N also can be exchangeable with each other and configured to be compatible, by providing both of a connection path from the front stage TDM switch 2 and a connection path after passing through the middle stage switch 3 and the back stage TDM switch 4.

In such configurations, for example, if it is assumed that the whole switch capacity required for one apparatus is L, it become to be possible to flexibly distribute the capacity L to a part for processing TDM signal and a part for processing packet signal. That is, it is possible to flexibly allocate the number of input and output interface units to be mounted for TDM signal and the number of input and output interface units to be mounted for packet signal.

Next, each operation of the case that TDM signal is inputted and the case that packet signal is inputted will be described.

First, as an operation for processing TDM signal, as described in FIG. 2, the TDM signal input interfaces 11-1 to 11-N execute SONET/SDH frame termination, and transfers the extracted payload data to the front stage TDM switch 2. In an operation of the front stage TDM switch 2, a port to be selected from the N:1 selectors 21-1 to 21-2N is set at each time slot in the TDM signal control memory 22, and one set is selected from N sets of input signal for each output port in the N:1 selectors 21-1 to 21-2N according to the setting.

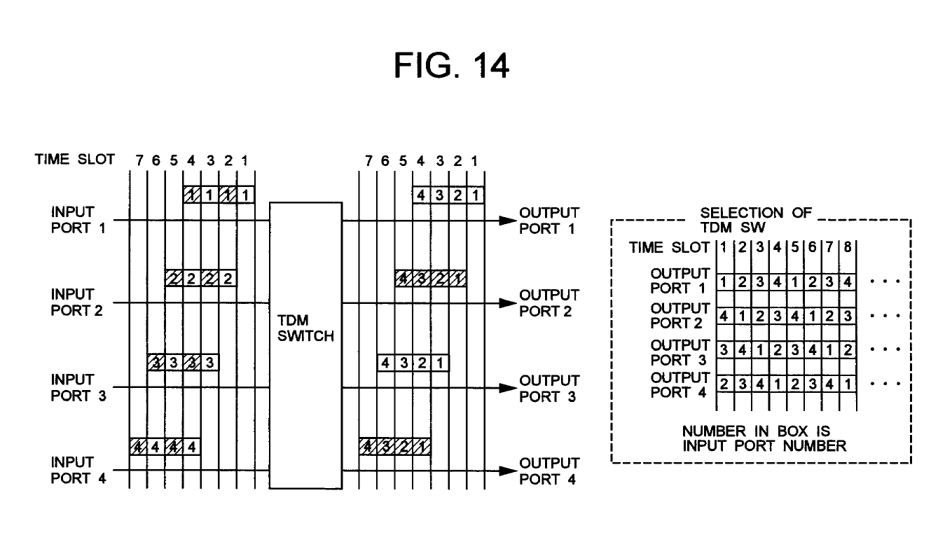

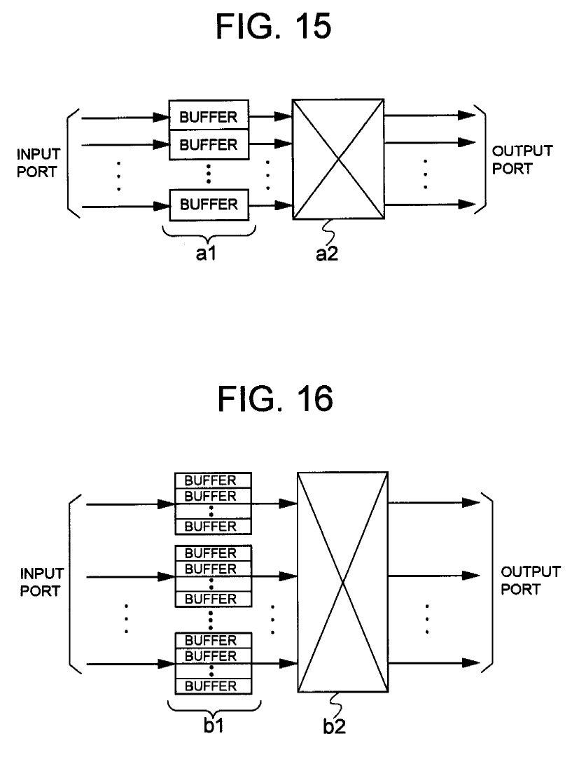

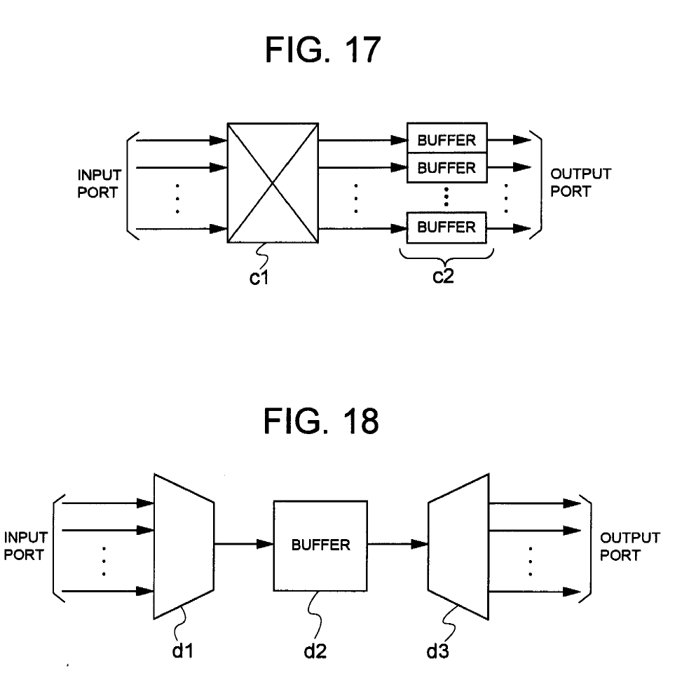

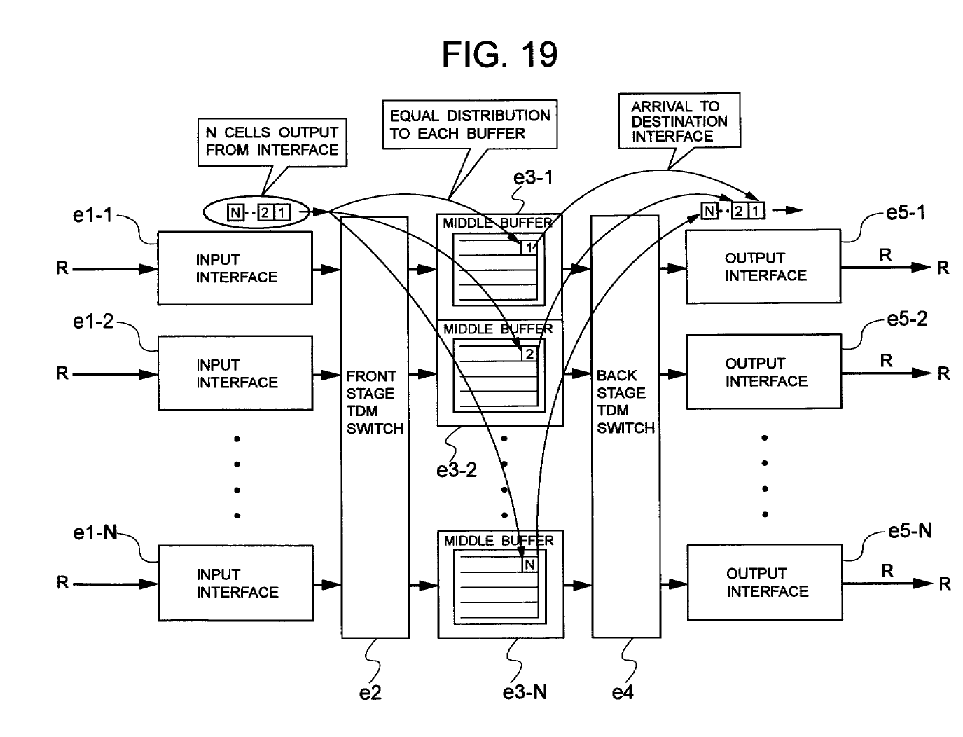

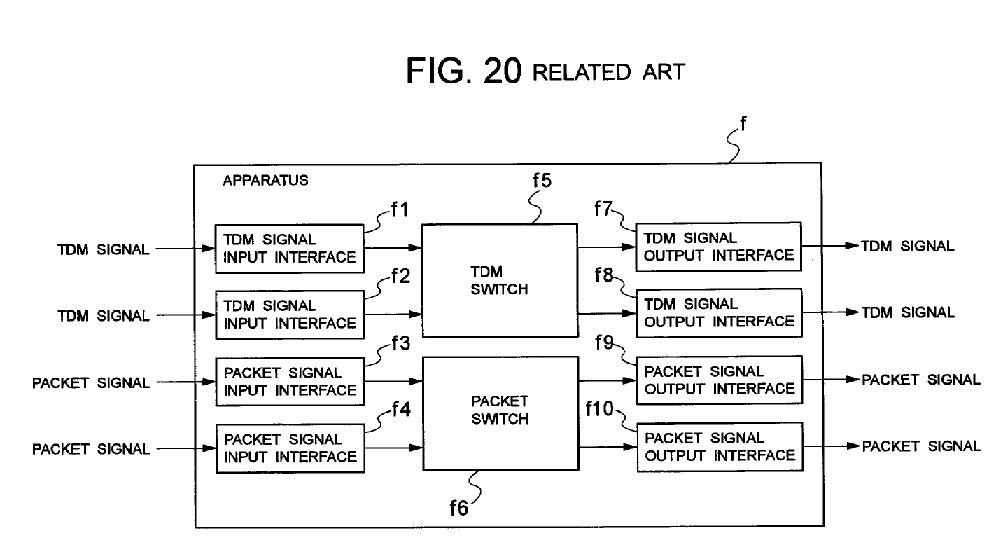

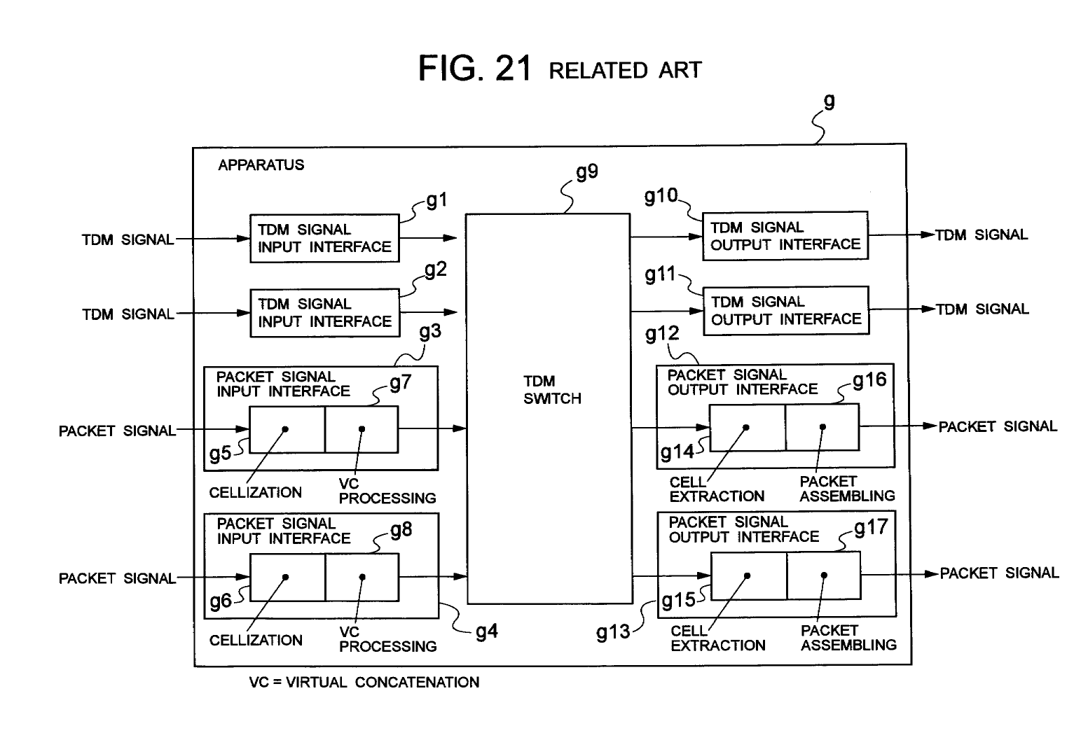

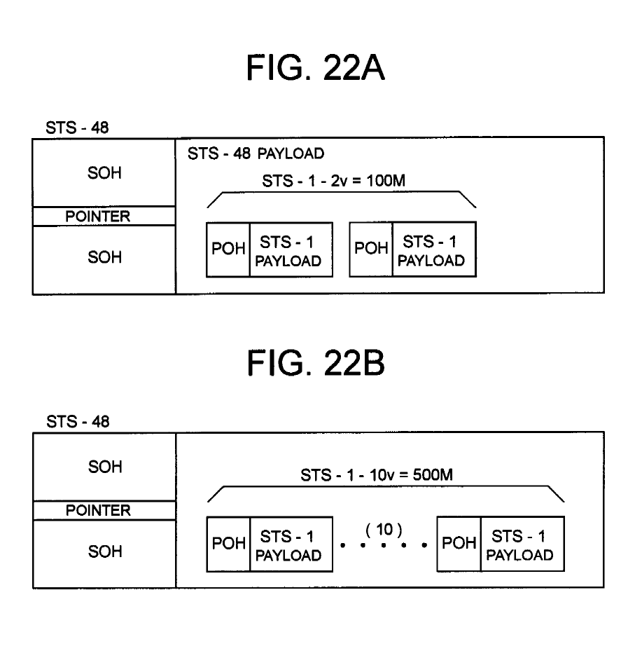

A setting image to the TDM signal control memory 22 is illustrated in FIG. 14. Here, the input port number selected at each time slot in each output port has been previously determined for inputted payload data, and the determination is previously set. In SONET/SDH frame, one time slot corresponds to one byte, and one channel data for the same destination is multiplexed by byte-interleave. That is, byte data of the same destination channel appears at a certain interval of time. In the front stage TDM 2, data multiplexed by byte is switched to the destination output port by selecting at the prescribed time slot with the above setting.

When TDM signal is inputted, the signal is directly connected to the TDM output interface unit 51-1 to 51-N in the output interfaces 5-1 to 5-N without passing through the middle stage switch 3 and the back stage TDM switch 4 illustrated in FIG. 1. As illustrated in FIG. 7, the TDM signal output interfaces 51-1 to 51-N generates SONET/SDH frame, puts data on the SONET/SDH frame, and outputs it as TDM signal.

Next, as illustrated in FIG. 3, an operation for processing packet signal cellizes inputted variable length packet signal to fixed length cells at the cellizing unit 121 to cause the subsequent processing to be easy, and in addition provides the destination information to each cell at the cell destination providing unit 122. An example of a cellized data format of this case is illustrated in FIG. 9.

This operation for cellizing identifies a destination of each packet signal, causes the destination information to be a destination for switching, and provides it as a destination port number (output port number) part in a cell header illustrated in FIG. 9. This destination port number is used for the identification in the middle stage switch 3 when the distribution for destination is executed in the back stage TDM switch 4 after load-balancing.

And, this operation for cellizing provides a source port number (input port number) indicating the port number of its own input interface as a source port number (input port number) part in a cell header illustrated in FIG. 9. This source port number is used to identify an input port in the case of separately queuing as VIQ (Virtual Input Queue) for each input port number which each switched cell has passed through when cells are finally assembled to packet at the packet signal output interfaces 52-1 to 52-N indicated later.

Further, information is provided in the cell header, which identifies the location of the divided cell in a packet such as head, middle, or tail, to assemble a packet in the packet signal output interfaces 52-1 to 52-N. Finally, actual packet signal is mounted on payload illustrated in FIG. 9 and is transferred to the front stage TDM switch 2.

An operation for processing packet signal cellized by the front stage TDM switch 2 is to equally distribute (load-balancing) cells to the middle stage VOQ (Virtual Output Queue) in the next middle stage switch 3. Because it is only to balance the load, an operation hereof is an operation of the TDM switch as illustrated in FIG. 14. That is, the operation is set so as to select the input port number at each time slot in such an order that the number is smaller, and repeat the selection to load-balance cells in each output port.

Here, differing from the case of the above TDM signal, in the case of processing packet signal, one time slot corresponds to one cell, and data transferred to the same destination continues during the number of bytes corresponding to one cell length. Thus, the packet signal control memory 23 sets a port to be selected for each cell in the N:1 selectors 21-(N+1) to 21-2N.

And, when packet signal is inputted, because the signal is connected to the middle stage switch 3, the N:1 selector 21-(N+1) to 21-2N illustrated in FIG. 4 are used as N:1 selector. However, in this case, while it is a setting for each cell, if it is such a configuration that data of the number of bytes corresponding to one cell length is continuously set to the same destination, the packet signal control memory 23 can be configured with same hardware as that of the above TDM signal control memory 22, and a hardware configuration for packet signal until the N:1 selectors 21-1 to 21-2N is not particularly different from that of TDM signal.

Further, if the cell load balancing to the middle stage VOQ is executed for each N cells after N cells of the same destination has been accumulated in the input interfaces 1-1 to 1-N, the cell order inversion is not induced because of the difference of cell accumulation state in the middle stage VOQ. According to the above setting, one set of signal are selected from N sets of input signal and transmitted to the middle stage switch 3 in the N:1 selectors 21-(N+1) to 21-2N.

As illustrated in FIG. 5, the middle stage switch 3 extracts cells to identify a cell header of inputted cell signal. This can be performed by causing the input interfaces 1-1 to 1-N, the front stage TDM switch 2, and the middle stage switch 3 to include common frame information indicating a beginning location of the cell. The cell header illustrated in FIG. 9 is identified by extracting cells, and a destination of each cell is identified with the destination port number information by the destination decision units 32-1 to 32-N.

After identifying the destination, the cells are divided for each destination and queued in the middle stage VOQ 23-1 to 23-N. This queuing for each destination is configured so that HOL blocking (Head Of Line blocking) described in Description of the Related Art is avoided, and each cell is caused to be easily read to the next back stage TDM switch 4 according to the instruction of the output timing control 34 when the switching to the destination is executed in the next back stage TDM switch 4.

Because it is previously set in the next back stage TDM switch 5 that each cell is switched to which output port if it is read from which one of the middle stage VOQ 33-1 to 33-N at which timing, according to the setting, the output timing control 34 controls the cell read timing for each identified destination.

Here, if the number of mounted ports of packet signal input output interface is K (1≦K≦N), only K sets of the cell extracting units, the destination decision units, and the middle stage VOQs are mounted respectively. This is why it is avoided that the circuit size is increased because more unnecessary cell extracting units, destination decision units, and middle stage VOQs are mounted if the number of mounted ports of packet signal input and output interface is K in such a configuration that the number of the input and output interfaces of TDM signal and packet signal is flexibly changed. In FIG. 5, the cell extracting units, destination decision units, and middle stage VOQs from K+1 to N are illustrated with dotted lines.

The back stage TDM switch 4 switches to an actual destination. Operation itself of switch unit is basically same as operation in the front stage TDM switch 2. That is, in the packet signal control memory 42, operation of the TDM switch as illustrated in FIG. 14 is set, and like the front stage TDM switch 2, one time slot corresponds to one cell, and data for the same destination continues during the number of bytes of one cell length, so that a port to be selected of the N:1 selectors 41-1 to 41-N is set for each cell. That is, the packet signal control memory 42 continuously sets the bytes corresponding to one cell length to the same destination.

According to this setting, the above output timing control unit 34 of the middle stage switch 3 reads cells from the middle stage VOQs 33-1 to 33-N in consideration of the destination timing, and then, the switching is completed. According to the above setting, one set is selected from N sets of input signal for each output port in the N:1 selectors 41-1 to 41-N, and is transmitted to the packet signal output interfaces 52-1 to 52-N.

As illustrated in FIG. 8, the packet signal output interfaces 52-1 to 52-N extract cells to identify a cell header of inputted cell signal. This can be performed by causing the input interfaces 1-1 to 1-N, the front stage TDM switch 2, the middle stage switch 3, the back stage TDM switch 4, and the output interfaces 5-1 to 5-N to include common frame information indicating a beginning location of the cell.

The packet signal output interfaces 52-1 to 52-N identifies a cell header illustrated in FIG. 9 by extracting cells, and identifies which port each cell has been transmitted from according to the source port number (input port number) information in the cell header in the source port number (input port number) decision unit 522. After identifying the source port, cells are divided for each source port and queued in VIQ 523. This queuing for each source port is performed to easily assemble cells in next packet assembling unit 524. For each cell read for each identified source port, the packet assembling unit 524 decides the location in a packet such as head, middle, or tail, and assemble packet according to the information, and returns it to the original signal to output.

As described above, in the packet signal processing, the load-balance type switch functions as a complete packet switch, which is configured with the input interfaces 1-1 to 1-N, the front stage TDM switch 2, the middle stage switch 3, the back stage TDM switch 4, and the output interfaces 5-1 to 5-N. That is, in such a configuration that packet data mapped on SONET/SDH frame with the related virtual concatenation is TDM-switched, the switching can be performed only at the mapped fixed band speed from an input port to an output port, on the other hand, in the load-balance type switch, it is possible to transmit cells at free band to any output port according to a destination of packet signal inputted from some port, so that switching paths of free band can be constructed.

As described above, in the first exemplary embodiment, because the TDM switch connection and the packet switch connection share a connection path between an input and output interface unit and an switch unit by causing the front stage TDM switch 2 to be a TDM packet hybrid switch used as shared with the switching of TDM signal in a configuration of the load-balance type switch for realizing switching of packet signal, it is possible to secure the flexibility of the mounting capacity distribution between TDM signal and packet signal in the whole switch capacity required for one apparatus.

And, in the first exemplary embodiment, because the front stage TDM switch 2 is used as shared with the switching of TDM signal in a configuration of the load-balance type switch for realizing the switching of packet signal, it is possible to realize the packet signal switching without limiting a path between input and output interface port to a fixed band speed in a TDM-packet hybrid switch.

### Second Exemplary Embodiment

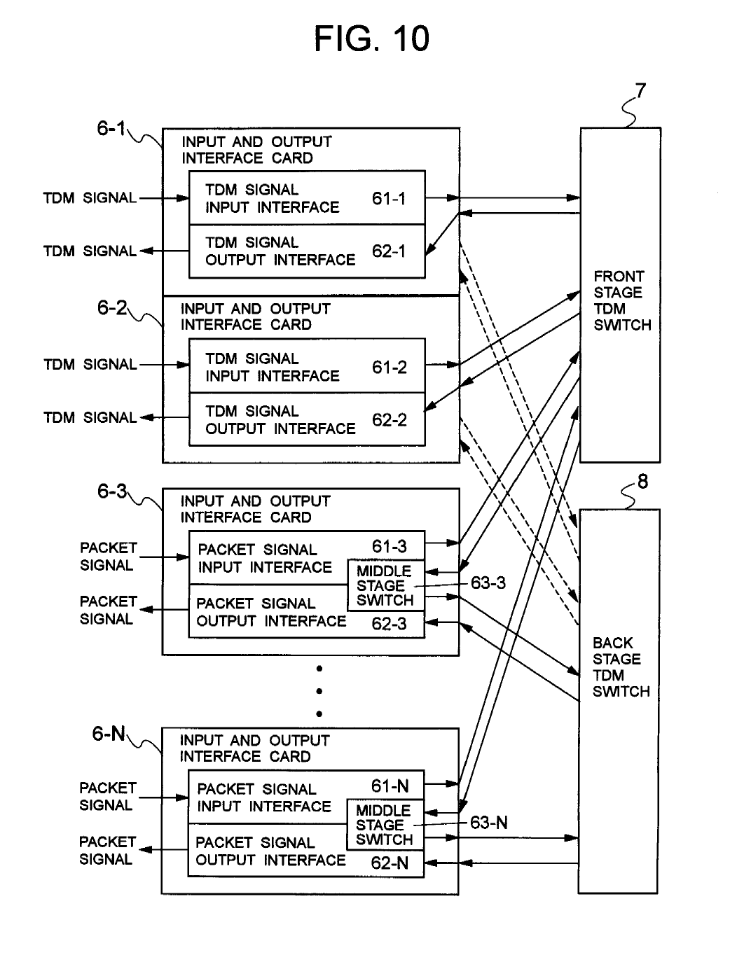

FIG. 10 is a block diagram illustrating a configuration example of a switch apparatus according to another exemplary embodiment of the present invention. In FIG. 10, another exemplary embodiment of the present invention has a same configuration as the switch apparatus according to the exemplary embodiment of the present invention illustrated in FIG. 1, except that the TDM signal input and output interface and the packet signal input and output interface are implemented on same interface cards 6-1 to 6-N, and the middle stage switches 63-1 to 63-N (the middle stage switches 63-1 to 63-2 are not illustrated) are provided as distributed for each card of the packet signal input and output interface units.

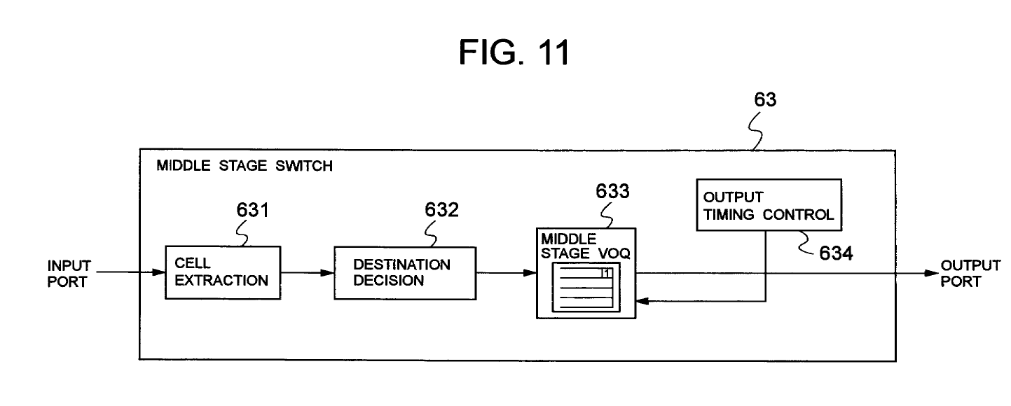

FIG. 11 is a block diagram illustrating a configuration example of a middle stage switch 63-1 to 63-N of FIG. 10. In FIG. 11, the middle stage switch 63-1 to 63-N (described as middle stage switch 63) includes a cell extracting unit 631 per one input and output port, a destination decision unit 632, a middle stage VOQ 633, and an output timing control unit 634, and the mounting number of the cell extracting unit, the destination decision unit, and the middle stage VOQ corresponds directly to the number of the packet signal input and output interface port. In the case of this configuration, as illustrated in FIG. 10, the input and output interface cards 6-1 to 6-N include both of a transmitting and receiving path with the front stage TDM switch 7 and a transmitting and receiving path with the back stage TDM switch 8.

When the TDM signal input and output interface is mounted, while it is actually enough to include only the transmitting and receiving path with the front stage TDM switch 7, the input and output interface cards 6-1 to 6-N of packet signal and TDM signal, in order to secure the flexibility of the mounting capacity distribution, include also connection paths (in FIG. 10, illustrated with dotted line) between all input and output interface cards 6-1 to 6-N and the back stage TDM switch 8 including the case that the TDM signal input and output interface is mounted.

The feature of this configuration is that a connection path from the front stage TDM switch 7 to the input and output interface cards 6-1 to 6-N is shared in the case of processing TDM signal and in the case of processing packet signal, and can be connected to the TDM signal output interfaces 62-1 and 62-2 in the case of processing TDM signal, and can be connected to the middle stage switches 62-3 to 62-N in the case of processing packet signal in a card.

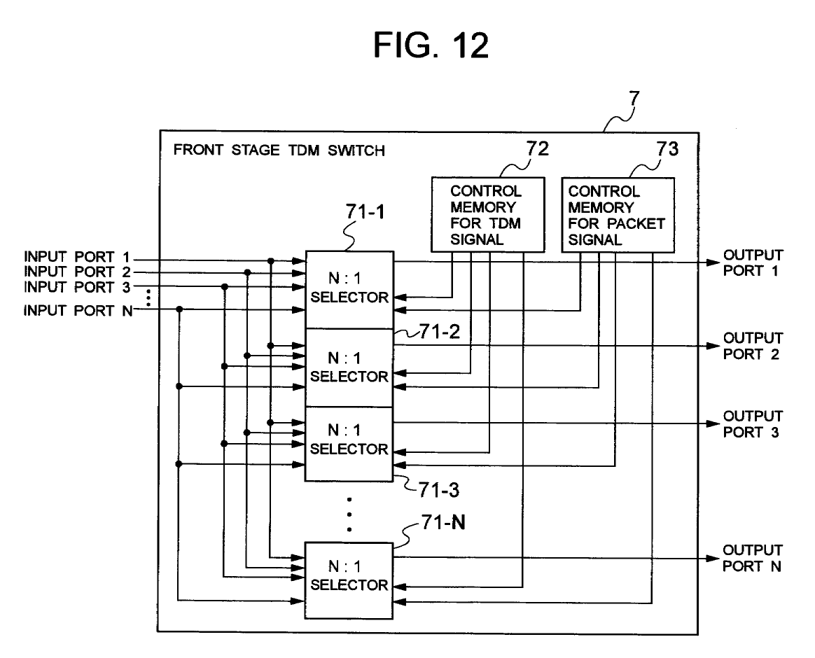

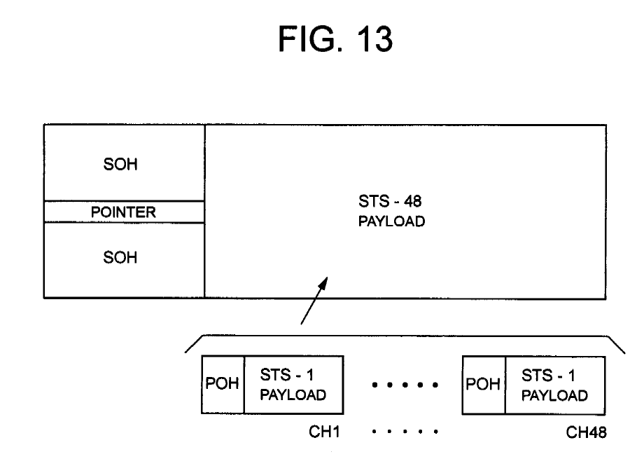

Thereby, because it becomes to be unnecessary to physically connect to different port such as the output interfaces 5-1 to 5-N in the case of processing TDM signal, and the middle stage switch 3 in the case of processing packet signal as an exemplary embodiment of the present invention illustrated in FIG. 1, the front stage TDM switch 7 needs not N×2N configuration (mounting 2N sets of N:1 selector) as illustrated in FIG. 4, but N×N configuration (N sets of N:1 selector 71-1 to 71-N) as illustrated in FIG. 12, so that a new effect is provided that the circuit size of the front stage TDM switch 7 can be drastically reduced.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A switch apparatus including a load-balance type switch which is configured with a front stage TDM switch, a middle stage switch, and a back stage TDM switch for realizing the switching of the packet signal, accommodating a TDM (Time Division Multiplex) signal and a packet signal, comprising:
the front stage TDM switch being shared and used for switching the TDM signal and switching the packet signal,
a connection path between an input interface and the front stage TDM switch being shared for a TDM switch connection and a packet switch connection, and the input interface of the TDM signal and the input interface of the packet signal being caused to be exchangeable with each other and configured to be compatible.

2. The switch apparatus according to claim 1,
wherein if the number of input and output interface ports of a system is N (N: positive integer), the front stage TDM switch is an N×2N switch which includes two circuits of output port for connecting with an output interface when N ports of the input interface of the TDM signal are mounted, and for connecting with the middle stage switch when N ports of the input interface of the packet signal are mounted.

3. The switch apparatus according to claim 1,
wherein in the configuration of the load-balance type switch, a connection path from the front stage TDM switch and the connection path after passing through the middle stage switch and the back stage TDM switch are provided for the connection path between a switch unit and the output interface, and the output interface of the TDM signal and the output interface of the packet signal are caused to be exchangeable with each other and configured to be compatible.

4. The switch apparatus according to claim 1,
wherein the front stage TDM switch comprising:
a control memory for the TDM signal; and
a control memory for the packet signal,
and wherein the front stage TDM switch executes TDM switching for each byte when the TDM signal is processed, executes the TDM switching for each cell which is divided into fixed length cells from a packet when the packet signal is processed, and realizes switching of each of the TDM signal and the packet signal.

5. The switch apparatus according to claim 1,
wherein in the load-balance type switch, the front stage TDM switch is shared and used for the switching of the TDM signal and the switching of the packet signal, and also in the switching of the packet signal, a path between an input interface port and an output interface port is not limited to a fixed band speed, and it is caused to transmit cells in a free band for any output port according to a destination of the packet signal inputting to some port.

6. A switching method used in a switch apparatus including a load-balance type switch which is configured with a front stage TDM switch, a middle stage switch, and a back stage TDM switch for realizing to switch the packet signal, accommodating a TDM (Time Division Multiplex) signal and a packet signal, comprising:
sharing and using the front stage TDM switch for switching the TDM signal and switching the packet signal;
sharing a connection path between an input interface and the front stage TDM switch for a TDM switch connection and a packet switch connection; and
causing the input interface of the TDM signal and the input interface of the packet signal to be exchangeable with each other and configured to be compatible.

7. The switching method according to claim 6,
wherein if the number of input and output interface ports of a system is N (N: positive integer), the front stage TDM switch is an N×2N switch which includes two circuits of output port for connecting with an output interface when N ports of the input interface of the TDM signal are mounted, and for connecting with the middle stage switch when N ports of the input interface of the packet signal are mounted.

8. The switching method according to claim 6,
wherein in the configuration of the load-balance type switch, a connection path from the front stage TDM switch and the connection path after passing through the middle stage switch and the back stage TDM switch are provided for the connection path between a switch unit and the output interface, and the output interface of the TDM signal and the output interface of the packet signal are caused to be exchangeable with each other and configured to be compatible.

9. The switching method according to claim 6,
wherein the front stage TDM switch comprises a control memory for the TDM signal and a control memory for the packet signal, executes TDM switching for each byte when the TDM signal is processed, executes the TDM switching for each cell which is divided into fixed length cells from a packet when the packet signal is processed, and realizes switching of each of the TDM signal and the packet signal.

10. The switching method according to claim 6,
wherein in the load-balance type switch, the front stage TDM switch is shared and used for the switching of the TDM signal and the switching of the packet signal, and also in the switching of the packet signal, a path between an input interface port and an output interface port is not limited to a fixed band speed, and it is caused to transmit cells in a free band for any output port according to a destination of the packet signal inputting to some port.

11. A switch apparatus including a load-balance type switch which is configured with a front stage TDM switch means, a middle stage switch means, and a back stage TDM switch means of realizing the switching of the packet signal, accommodating a TDM (Time Division Multiplex) signal and a packet signal, comprising:
the front stage TDM switch means being shared and used for switching the TDM signal and switching the packet signal,
a connection path between an input interface and the front stage TDM switch means being shared for a TDM switch connection and a packet switch connection,
and the input interface of the TDM signal and the input interface of the packet signal being caused to be exchangeable with each other and configured to be compatible.
